(19) United States
(12) Patent Application Publication
(10) Pub. No.: US 2023/0226670 A1
(43) Pub. Date: Jul. 20, 2023

(54) Screw Gun with Additional Trigger

(71) Applicant: Kurtis Dean Mitthun, Meservey, IA (US)

(72) Inventor: Kurtis Dean Mitthun, Meservey, IA (US)

(21) Appl. No.: 17/935,842

(22) Filed: Sep. 27, 2022

Related U.S. Application Data
(63) Continuation-in-part of application No. 29/825,652, filed on Feb. 3, 2022.
(60) Provisional application No. 63/301,150, filed on Jan. 20, 2022.

(51) Int. Cl. B25B 21/02; B25F 5/02

(52) U.S. Cl. CPC B25B 21/02; B25F 5/02

(57) ABSTRACT

The present invention has a primary trigger, a secondary trigger, an electrical circuit, a screw head, a front side, and a reverse button. The electrical circuit is an internal system that provides electrical power to the present invention. The screw head is a metal component capable of locking into an external screw with a Philips head or flat head. The reverse button is an electrical button that reverses the rotational direction of the screw head. The electrical circuit is positioned within the present invention. The electrical circuit has a battery and a potentiometer. The screw head has a motor that rotates the screw head. The primary trigger is positioned directly next to the secondary trigger for each to easily be compressed simultaneously. The screw head is positioned offset the primary trigger to ensure no interference with the screw head rotation or oscillation.

### FIELD OF THE INVENTION

The present invention relates generally to a screw gun with a secondary trigger to create a hammering function. More specifically, the present invention is a device that creates a hammering motion to set a screw within hardwood or metal structure.

### BACKGROUND OF THE INVENTION

Within the construction industry screws, nails and other fasteners are used in a variety of projects to properly secure objects to one another. Each type of fastener has its own pros and cons for securing objects, and each of the fasteners usually have accompanying tools to aid the process of securing the fastener. With screws, screw guns, drills, impact drivers, and other tools can be used to create the proper torque necessary to fasten the screw within a material. While most tools can properly turn the screw into a desired material, many have issued when the material is has a smooth surface and a dense interior like a hard wood or a metal material. This causes issues when attempting to start the screwing process and getting the proper initial hole to start the screwing process. Many individuals attempt to solve this by using their tool to hit the screw into the material before screwing the screw. This method causes both inaccurate positioning of the screw and can potentially damage the tool being used to hit the screw into place. Further, other methods include using a drill to drill a starter hole within the material. This method, however, requires additional tools and cannot be used for some materials or projects to ensure the structural integrity is not compromised.

An objective of the present invention is to provide users with a secondary trigger on a screw gun, to help create a hamming motion. The present invention intends to provide users with a device that can hammer and rotate a screw properly into place. In order to accomplish that, a preferred embodiment of the present invention comprises a main trigger and a secondary trigger. Further, the secondary trigger is equipped with a potentiometer to control the speed of the hammering motion. Thus, the present invention is a secondary trigger for a screw gun to create a hammering motion for setting screws into a material before rotational motion.

### BRIEF DESCRIPTION OF THE DRAWINGS

FIG. 1 is a perspective view of the present invention.

FIG. 2 is a rear perspective view of the present invention.

FIG. 3 is block diagram view of the present invention.

### DETAIL DESCRIPTIONS OF THE INVENTION

All illustrations of the drawings are for the purpose of describing selected versions of the present invention and are not intended to limit the scope of the present invention.

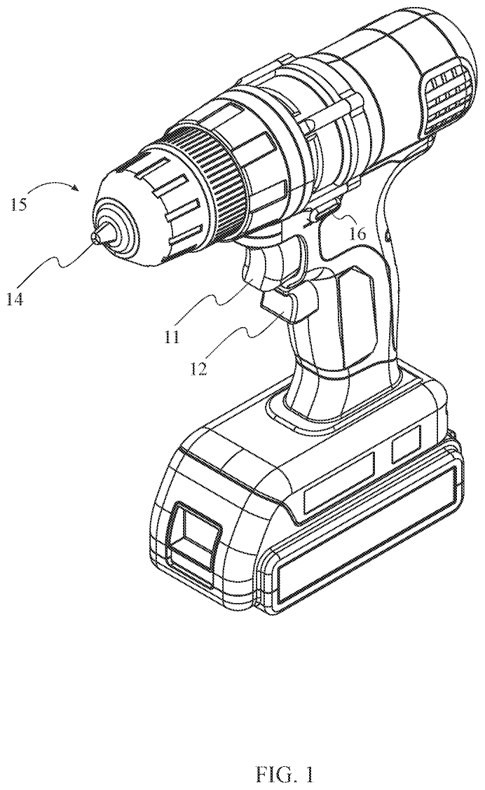

The preferred embodiment of the present invention comprises a primary trigger 11, a secondary trigger 12, an electrical circuit 13, a screw head 14, a front side 15, and a reverse button 15 as shown in FIG. 1. The electrical circuit 13 is an internal system that provides electrical power to the present invention. The screw head 14 is a metal component with a pointed cross end or a flat end capable of locking into an external screw with a Philips head or flat head. The reverse button 15 is an electrical button that directs the flow of the electrical power within the electrical circuit 13. The electrical circuit 13 comprises a battery 131 and a potentiometer 132. The screw head 14 comprises a motor 141. The primary trigger 11 is positioned adjacent to the secondary trigger 12. As a result, the primary trigger 11 and secondary trigger 12 are easily accessible by a finger when utilizing the present invention. The electrical circuit 13 is positioned within the present invention. Consequently, the electrical circuit 13 it protected from the outer elements that could potentially damage the electrical circuit 13. The screw head 14 is positioned offset the primary trigger 11. Accordingly, the screw head 14 is not mechanically connected to the primary trigger 11 or interfere in the surrounding space.

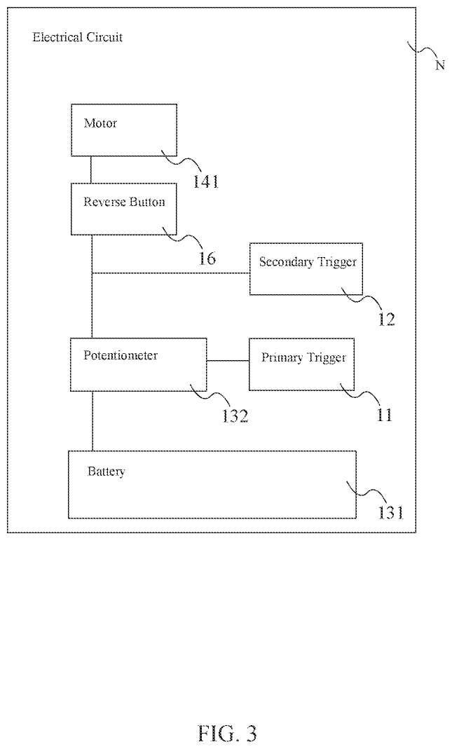

In reference to FIG. 3, the primary trigger 11 is electronically connected to the electrical circuit 13. Thus, the primary trigger 11 can initiate an electrical current being sent through the electrical circuit 13. The electrical circuit 13 is electronically connected to the screw head 14. So, the electrical circuit 13 can carry electrical power to the screw head 14. The secondary trigger 12 is electronically connected to the electrical circuit 13. As a result, the secondary trigger 12 can initiate an electrical current being sent through the electrical circuit 13. The reverse button 15 is electronically connected to the electrical circuit 13. Consequently, the reverse button 15 can initiate an electrical current being sent through the electrical circuit 13.

Further, the screw head 14 is positioned along the front side 15 of the present invention as shown in FIG. 1. Accordingly, the screw head 14 is positioned correctly to fasten or hammer screws into a material. The screw head 14 rotates in place fixed to the present invention. Thus, the screw head 14 can rotatably secure a screw into a material. The screw head 14 oscillates at the front of the present invention. So, the screw head 14 can initially thrust a screw into a hard material with a lateral hammer like motion.

Furthermore, the screw head 14 rotates clockwise as the primary trigger 11 is compressed. As a result, the screw head 14 rotates in a primary direction only when the primary trigger 11 is pulled to secure a screw into a material. The screw head 14 rotates counter-clockwise as the primary trigger 11 is compressed and the reverse button 15 is compressed. Consequently, the screw head 14 is rotates the opposite direction only when the primary trigger 11 is pulled and the reverse button 15 is pressed. The screw head 14 oscillates at the front end of the present invention as the secondary trigger 12 is compressed as seen in FIG. 1. Accordingly. The screw head 14 oscillates with a lateral hammer like motion only when the secondary trigger 12 is pulled.

In reference to FIG. 1, the motor 141 provides rotational force to the screw head 14. Thus, the motor 141 is mechanically connected to the screw head 14 and translates electrical power into a rotational force to spin the screw head 14 in the desired direction. The motor 141 provides lateral force to the screw head 14. So, the motor 141 through the mechanical connection to the screw head 14 provides an additional lateral force when the secondary trigger 12 is pulled.

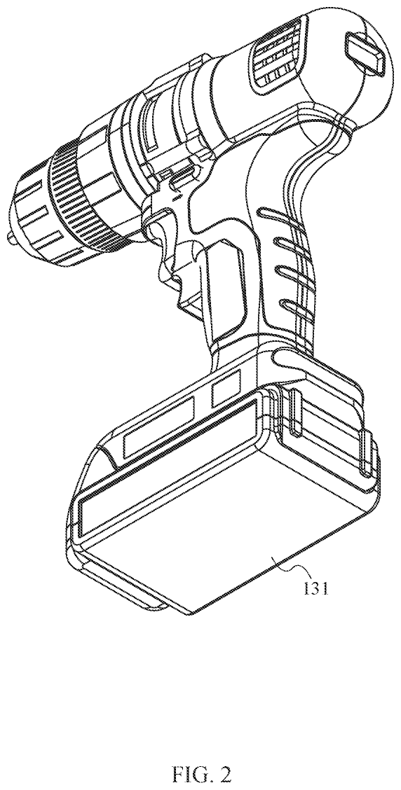

Furthermore, the battery 131 provides electrical power to the electrical circuit 13 as shown in FIG. 2. As a result, the battery 131 sends a voltage with a current to the various components within the present invention that require electrical power. The electrical circuit 13 is electrically connected to the motor 141. Consequently, the electrical circuit 13 provides the motor 141 with the electrical power necessary to create a rotational and lateral force for setting and securing screws into a material. The potentiometer 132 limits the amount of electrical power passing to the motor 141. Accordingly, the potentiometer 132 allows the amount of power reaching the motor 141 is adjustable and not just an either on or off setting. The primary trigger 11 is compressed and controls the amount the potentiometer 132 limits the power. Thus, as the primary trigger 11 is compressed the amount of electrical power reaching the motor 141 is linearly increased to ensure the screw head 14 rotates faster as the primary trigger 11 is further compressed.

Although the invention has been explained in relation to its preferred embodiment, it is to be understood that many other possible modifications and variations can be made without departing from the spirit and scope of the invention as hereinafter claimed.

What is claimed is:

1. A screw gun with an additional trigger comprising:
a primary trigger;
a secondary trigger;
an electrical circuit;
a screw head;
a front side;
a reverse button;
the electrical circuit comprising a battery and a potentiometer;
the screw head comprising a motor;
the primary trigger being positioned adjacent to the secondary trigger;
the electrical circuit being positioned within the present invention; and
the screw head being positioned offset the primary trigger.

2. The screw gun with an additional trigger as claimed in claim 1 comprising:
the primary trigger being electronically connected to the electrical circuit;
the electrical circuit being electronically connected to the screw head;
the secondary trigger being electronically connected to the electrical circuit; and
the reverse button being electronically connected to the electrical circuit.

3. The screw gun with an additional trigger as claimed in claim 2 comprising:
the screw head being positioned along the front side of the present invention;
the screw head rotating in place fixed to the present invention; and
the screw head oscillating at the front of the present invention.

4. The screw gun with an additional trigger as claimed in claim 3 comprising:
the screw head rotating clockwise as the primary trigger is compressed; and
the screw head rotating counter-clockwise as the primary trigger is compressed and the reverse button is compressed.

5. The screw gun with an additional trigger as claimed in claim 3 wherein the screw head oscillating at the front end of the present invention as the secondary trigger is compressed.

6. The screw gun with an additional trigger as claimed in claim 3 comprising:
the motor providing rotational force to the screw head; and
the motor providing lateral force to the screw head.

7. The screw gun with an additional trigger as claimed in claim 3 comprising:
the battery providing electrical power to the electrical circuit;
the electrical circuit being electrically connected to the motor; and
the potentiometer limiting the amount of electrical power passing to the motor.

8. The screw gun with an additional trigger as claimed in claim 7 wherein the distance the primary trigger being compressed controlling the amount the potentiometer limits the power.

9. A screw gun with an additional trigger comprising:
a primary trigger;
a secondary trigger;
an electrical circuit;
a screw head;
a front side;
a reverse button;
the electrical circuit comprising a battery and a potentiometer;
the screw head comprising a motor;
the primary trigger being positioned adjacent to the secondary trigger;
the electrical circuit being positioned within the present invention;
the screw head being positioned offset the primary trigger;
the primary trigger being electronically connected to the electrical circuit;
the electrical circuit being electronically connected to the screw head;
the secondary trigger being electronically connected to the electrical circuit; and
the reverse button being electronically connected to the electrical circuit.

10. The screw gun with an additional trigger as claimed in claim 9 comprising:
the screw head being positioned along the front side of the present invention;
the screw head rotating in place fixed to the present invention; and
the screw head oscillating at the front of the present invention.

11. The screw gun with an additional trigger as claimed in claim 10 comprising:
the screw head rotating clockwise as the primary trigger is compressed; and
the screw head rotating counter-clockwise as the primary trigger is compressed and the reverse button is compressed.

12. The screw gun with an additional trigger as claimed in claim 10 wherein the screw head oscillating at the front end of the present invention as the secondary trigger is compressed.

13. The screw gun with an additional trigger as claimed in claim 10 comprising:
the motor providing rotational force to the screw head; and
the motor providing lateral force to the screw head.

14. The screw gun with an additional trigger as claimed in claim 10 comprising:
the battery providing electrical power to the electrical circuit;
the electrical circuit being electrically connected to the motor; and
the potentiometer limiting the amount of electrical power passing to the motor.

15. The screw gun with an additional trigger as claimed in claim 14 wherein the distance the primary trigger being compressed controlling the amount the potentiometer limits the power.

16. A screw gun with an additional trigger comprising:
a primary trigger;
a secondary trigger;
an electrical circuit;
a screw head;
a front side;
a reverse button;
the electrical circuit comprising a battery and a potentiometer;
the screw head comprising a motor;
the primary trigger being positioned adjacent to the secondary trigger;
the electrical circuit being positioned within the present invention;
the screw head being positioned offset the primary trigger;
the primary trigger being electronically connected to the electrical circuit;
the electrical circuit being electronically connected to the screw head;
the secondary trigger being electronically connected to the electrical circuit;
the reverse button being electronically connected to the electrical circuit;
the screw head being positioned along the front side of the present invention;
the screw head rotating in place fixed to the present invention; and
the screw head oscillating at the front of the present invention.

17. The screw gun with an additional trigger as claimed in claim 16 comprising:
the screw head rotating clockwise as the primary trigger is compressed;
the screw head rotating counter-clockwise as the primary trigger is compressed and the reverse button is compressed; and
the screw head oscillating at the front end of the present invention as the secondary trigger is compressed.

18. The screw gun with an additional trigger as claimed in claim 3 comprising:
the motor providing rotational force to the screw head; and
the motor providing lateral force to the screw head.

19. The screw gun with an additional trigger as claimed in claim 3 comprising:
the battery providing electrical power to the electrical circuit;
the electrical circuit being electrically connected to the motor; and
the potentiometer limiting the amount of electrical power passing to the motor.

20. The screw gun with an additional trigger as claimed in claim 7 wherein the distance the primary trigger being compressed controlling the amount the potentiometer limits the power.
